(19) United States
(12) Patent Application Publication
(10) Pub. No.: US 2025/0104367 A1
(43) Pub. Date: Mar. 27, 2025

(54) SYSTEMS AND METHODS OF LAYOUT AND PRESENTATION FOR CREATIVE WORKFLOWS

(71) Applicant: Apple Inc., Cupertino, CA (US)

(72) Inventors: David H. HUANG, San Mateo, CA (US); Randal W. LAMORE, San Francisco, CA (US); Soravis PRAKKAMAKUL, Emeryville, CA (US); Valentin F. ROUSSELLET, Culver City, CA (US)

(21) Appl. No.: 18/892,242

(22) Filed: Sep. 20, 2024

Related U.S. Application Data
(60) Provisional application No. 63/585,193, filed on Sep. 25, 2023.

(51) Int. Cl. G06T 19/00

(52) U.S. Cl. CPC G06T 19/006

(57) ABSTRACT

Some examples of the disclosure are directed to systems and methods for displaying three-dimensional models of virtual three-dimensional environments. In some examples, the three-dimensional model includes representations of the virtual object(s) included in the environment, a representation of a viewpoint of a user of the electronic device in the environment, and a representation of a viewpoint of a second user of a different electronic device in the environment. In some examples, in response to receiving an input requesting to display the virtual three-dimensional environment (e.g., at full size), the electronic device displays the virtual three-dimensional environment from the viewpoint of the user of the electronic device indicated in the model.

### CROSS-REFERENCE TO RELATED APPLICATION

This application claims benefit of U.S. Provisional Patent Application No. 63/585,193, filed Sep. 25, 2023, the contents of which is hereby incorporated by reference in its entirety for all purposes.

### FIELD OF THE DISCLOSURE

This relates generally to systems and methods of presenting virtual three-dimensional environments and, more particularly, to displaying three-dimensional models of virtual three-dimensional environments.

### BACKGROUND OF THE DISCLOSURE

Some computer graphical environments provide two-dimensional and/or three-dimensional environments where at least some objects presented for a user's viewing are virtual and generated by a computer. In some examples, virtual three-dimensional environments can be based on one or more images of the physical environment of the computer. In some examples, virtual three-dimensional environments do not include images of the physical environment of the computer.

### SUMMARY OF THE DISCLOSURE

This relates generally to systems and methods of presenting virtual three-dimensional environments and, more particularly, to displaying three-dimensional models of virtual three-dimensional environments. In some examples, the three-dimensional model of a virtual three-dimensional environment includes representations of the virtual object(s) included in the environment, a representation of a viewpoint of a user of the electronic device in the environment, and a representation of a viewpoint of a second user of a different electronic device in the environment. In some examples, in response to receiving an input requesting to display the virtual three-dimensional environment (e.g., at full size), the electronic device displays the virtual three-dimensional environment from the viewpoint of the user of the electronic device indicated in the model.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIG. 3A illustrates an electronic device displaying a three-dimensional model of a virtual three-dimensional environment according to some examples of the disclosure.

FIG. 3B illustrates the electronic device displaying a preview of the virtual three-dimensional environment in accordance with some examples of the disclosure.

FIG. 3C illustrates the electronic device displaying the virtual three-dimensional environment concurrently with the model according to some examples of the disclosure.

FIG. 3D illustrates the electronic device displaying the virtual three-dimensional environment without displaying the model according to some examples of the disclosure.

FIGS. 4A-4F illustrate examples of the electronic device interacting with the model according to some examples of the disclosure.

FIGS. 5A-5B illustrate updating the viewpoint of a user in a virtual three-dimensional environment and the position of a representation of the user in a model of the virtual three-dimensional environment in response to movement of the electronic device in the physical environment according to some examples of the disclosure.

FIG. 6A illustrates the electronic device displaying a two-dimensional image of the virtual three-dimensional environment concurrently with a model of the virtual three-dimensional environment according to some examples of the disclosure.

FIG. 6B illustrates the electronic device 101 displaying a three-dimensional image 618 captured by a virtual camera 614 positioned and oriented in model 605 according to some examples of the disclosure.

FIG. 7 illustrates the electronic device displaying a plurality of virtual images through of the virtual three-dimensional environment concurrently with a view of the virtual three-dimensional environment corresponding to one of the images according to some examples of the disclosure.

FIG. 8 is a flow chart of a method of displaying a model of a virtual three-dimensional environment according to some examples of the disclosure.

### DETAILED DESCRIPTION

This relates generally to systems and methods of presenting virtual three-dimensional environments and, more particularly, to displaying three-dimensional models of virtual three-dimensional environments. In some examples, the three-dimensional model of a virtual three-dimensional environment includes representations of the virtual object(s) included in the environment, a representation of a viewpoint of a user of the electronic device in the environment, and a representation of a viewpoint of a second user of a different electronic device in the environment. In some examples, in response to receiving an input requesting to display the virtual three-dimensional environment (e.g., at full size), the electronic device displays the virtual three-dimensional environment from the viewpoint of the user of the electronic device indicated in the model.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

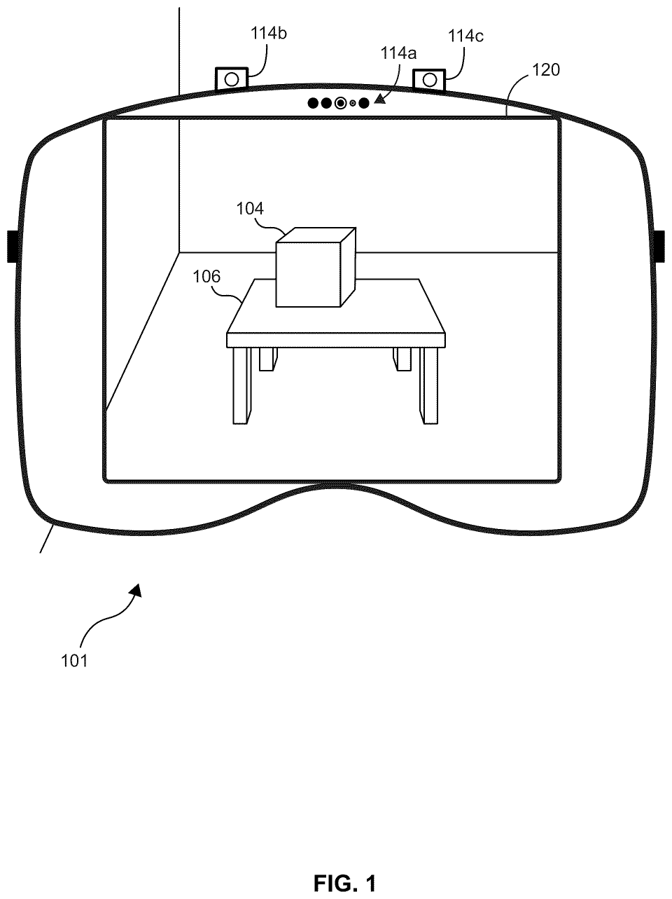

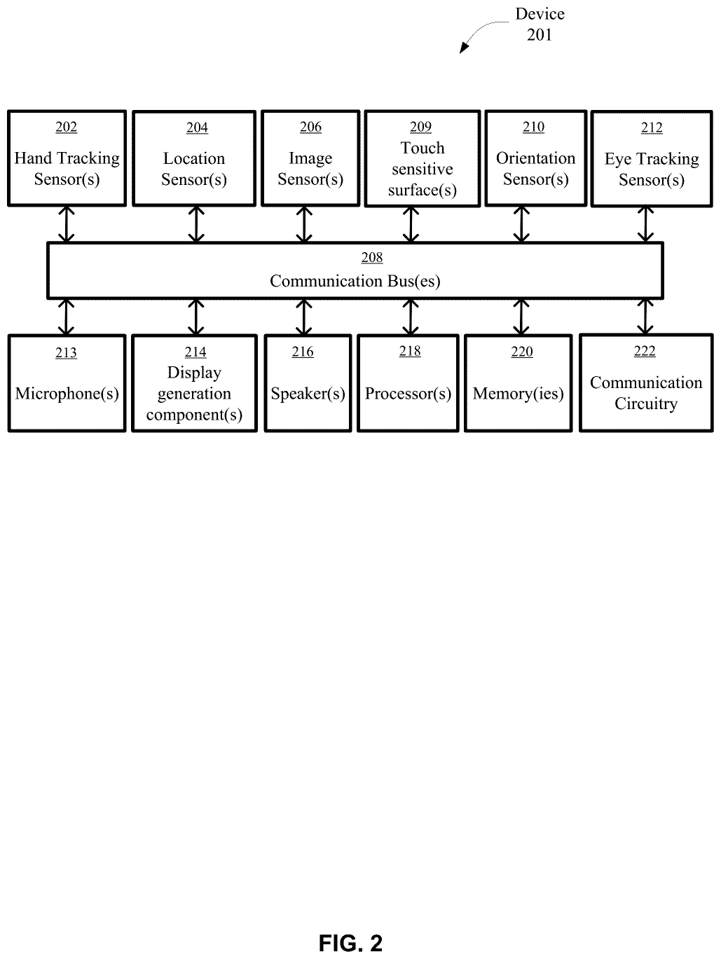

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101) using display 120.

In some examples, as shown in FIG. 1, display 120 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, display 120 also includes external image sensors 114b and 114c facing outwards from the user to detect and/or capture the physical environment of the electronic device 101 and/or movements of the user's hands or other body parts.

In some examples, display 120 has a field of view (e.g., a field of view captured by external image sensors 114b and 114c and/or visible to the user via display 120). Because display 120 is optionally part of a head-mounted device, the field of view of display 120 is optionally the same as or similar to the field of view of the user's eyes. In some examples, display 120 is a transparent or translucent display through which portions of the physical environment in the field of view of electronic device 101. For example, the computer-generated environment includes optical see-through or video-passthrough portions of the physical environment in which the electronic device 101 is located.

In some examples, in response to a trigger, the electronic device 101 may be configured to display a virtual object 104 in the XR environment represented by a cube illustrated in FIG. 1, which is not present in the physical environment, but is displayed in the XR positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 can use image sensor(s) 206 (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

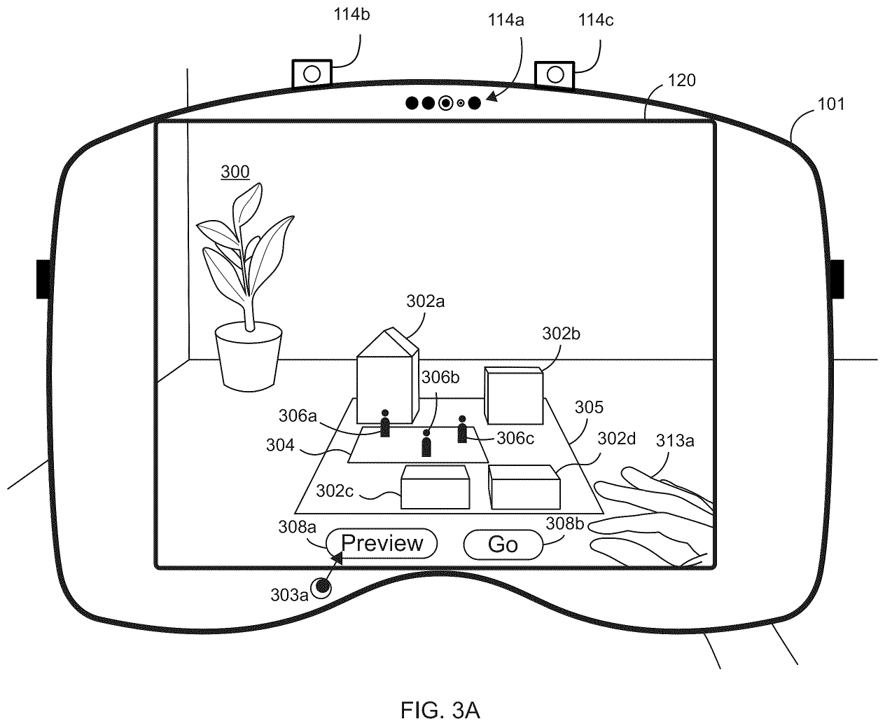

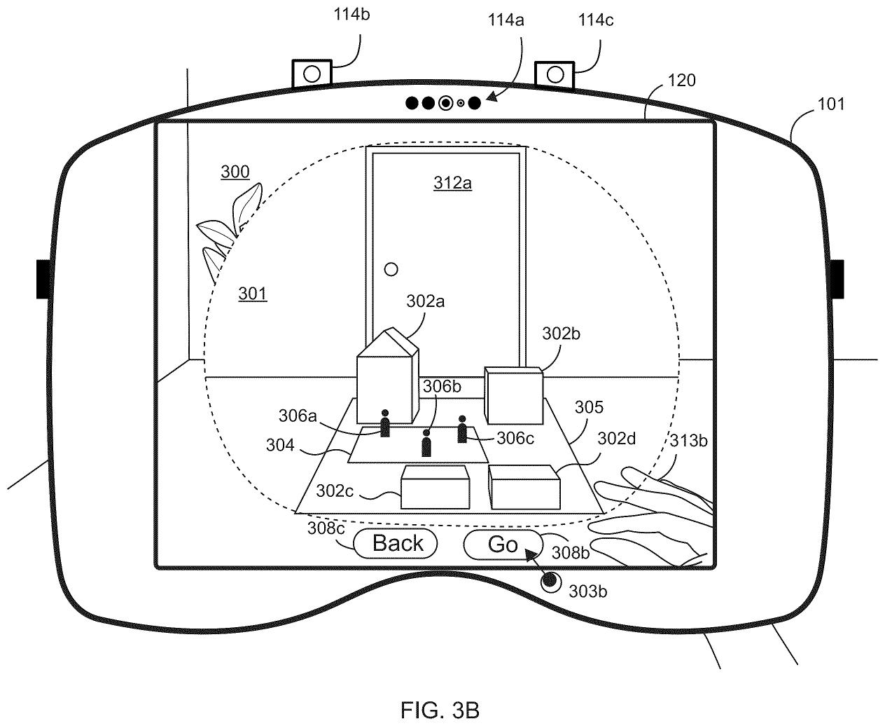

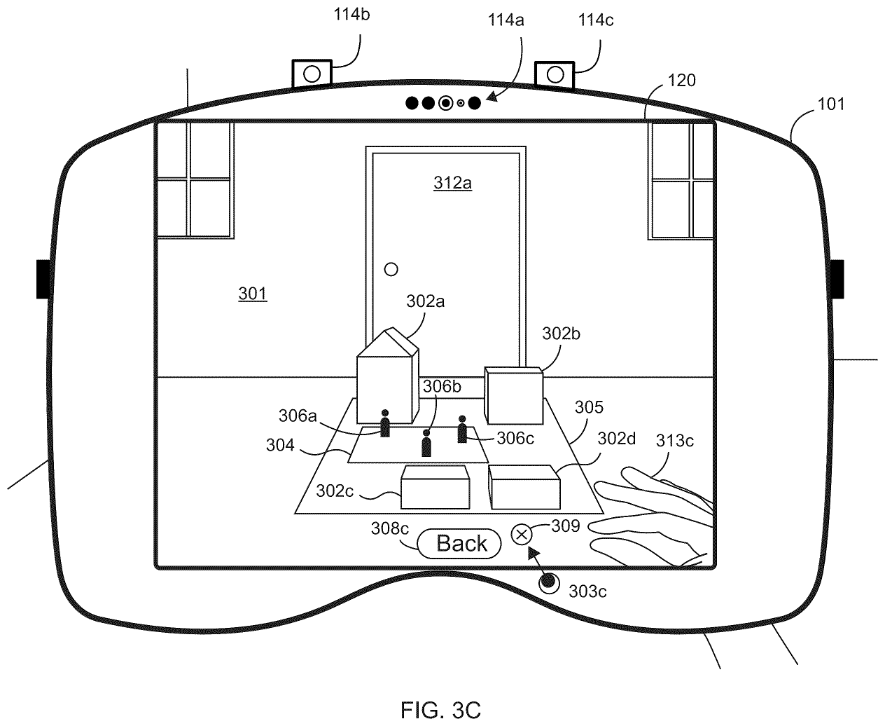

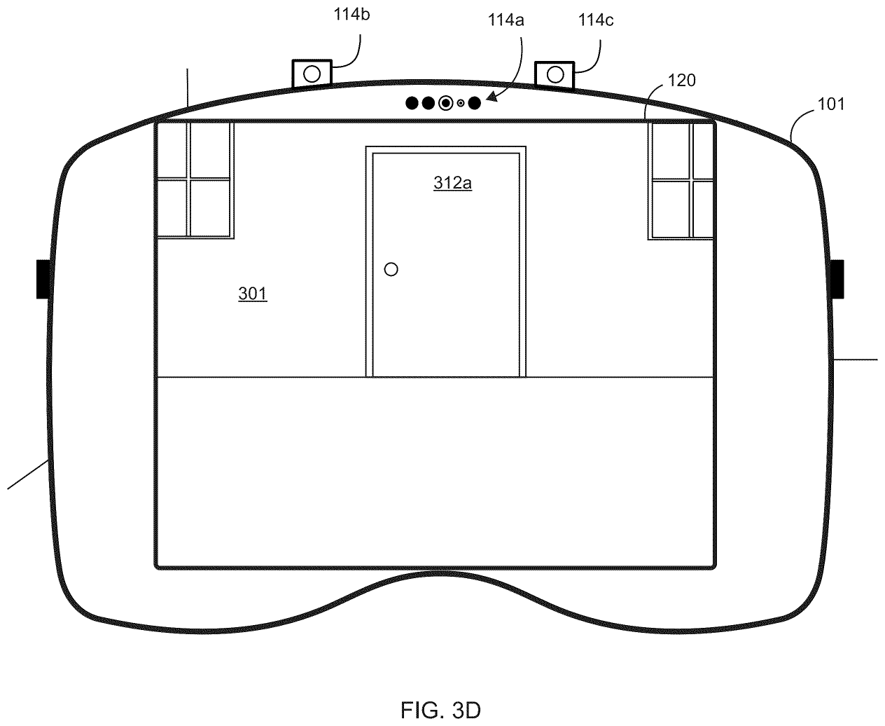

FIG. 3A illustrates an electronic device 101 displaying a three-dimensional model 305 of a virtual three-dimensional environment according to some examples of the disclosure. In some examples, the electronic device 101 is of the same architecture as electronic device 101 described above with reference to FIG. 1 and/or electronic device 201 described above with reference to FIG. 2.

In FIG. 3A, the electronic device 101 displays a three-dimensional model 305 of a virtual three-dimensional environment. In some examples, the virtual three-dimensional environment is an immersive virtual reality (VR) environment to which the electronic device 101 and, in some examples, one or more additional electronic devices have access. The virtual three-dimensional environment optionally includes virtual scenery including one or more virtual objects. As shown in FIG. 3A, the electronic device 101 displays model 305 with a view of the physical environment 300 of the electronic device 101 and without displaying the virtual three-dimensional environment, for example. In some examples, presenting the view of the physical environment includes presenting a view of a real object 314 (e.g., a houseplant). The electronic device optionally presents the view of the physical environment using see-through or video passthrough. In some examples, the electronic device 101 displays the model 305 concurrently with a preview of the virtual three-dimensional environment, such as in FIG. 3B. In some examples, the electronic device 101 displays the model 305 concurrently with the three-dimensional environment, such as in FIG. 3C.

In some examples, as shown in FIG. 3A, the model 305 includes representations 302a through 302d of virtual objects (e.g., buildings) included in the virtual three-dimensional environment. The representations 302a through 302d of the virtual objects are optionally displayed at sizes that are scaled-down from the sizes of the corresponding virtual objects included in the virtual three-dimensional environment. In some examples, the spatial arrangement of the representations 302a through 302d of the virtual objects in the model 305 corresponds to the spatial arrangement of the corresponding virtual objects in the virtual three-dimensional environment.

In some examples, the model 305 further includes a representation 306a of the user of the electronic device 101 and representations 306b and 306c of other users of other electronic devices. In some examples, the electronic device 101 is in communication with the other electronic devices in use by the other users. For example, the electronic devices are participating in a communication session that includes presenting one or more shared virtual objects. The spatial arrangement of representations 306a through 306c relative to each other optionally corresponds to the spatial arrangement of the user of the electronic device 101 and the other users of the other electronic devices in the physical environment of the electronic device 101. The spatial arrangement of the representations 306a through 306c relative to the representations 302a through 302d of virtual objects in the model optionally corresponds to the spatial arrangement of the users relative to the virtual objects of the virtual three-dimensional environment when the electronic devices display the virtual three-dimensional environment. For example, the location and, optionally, orientation of the representation 306a of the user of the electronic device 101 corresponds to a viewpoint of the user of the electronic device 101 in the virtual three-dimensional environment when the electronic device 101 displays the virtual three-dimensional environment, such as in FIG. 3C.

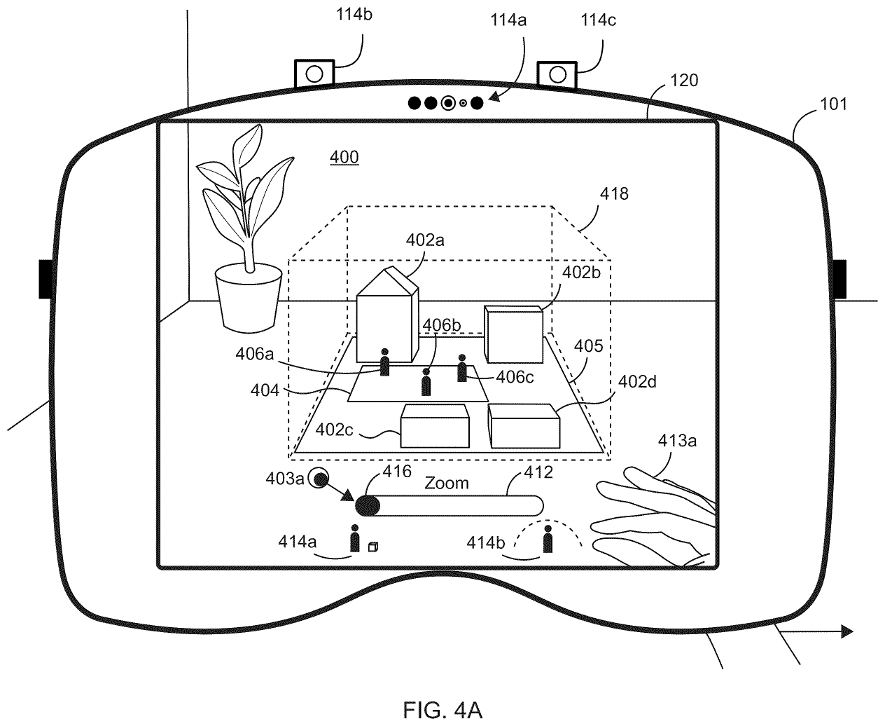

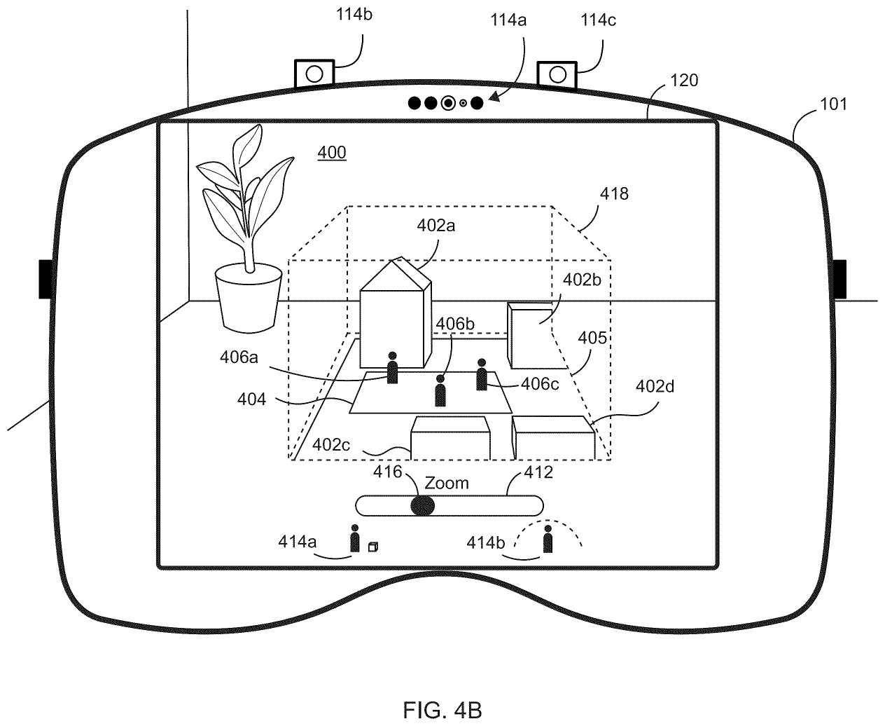

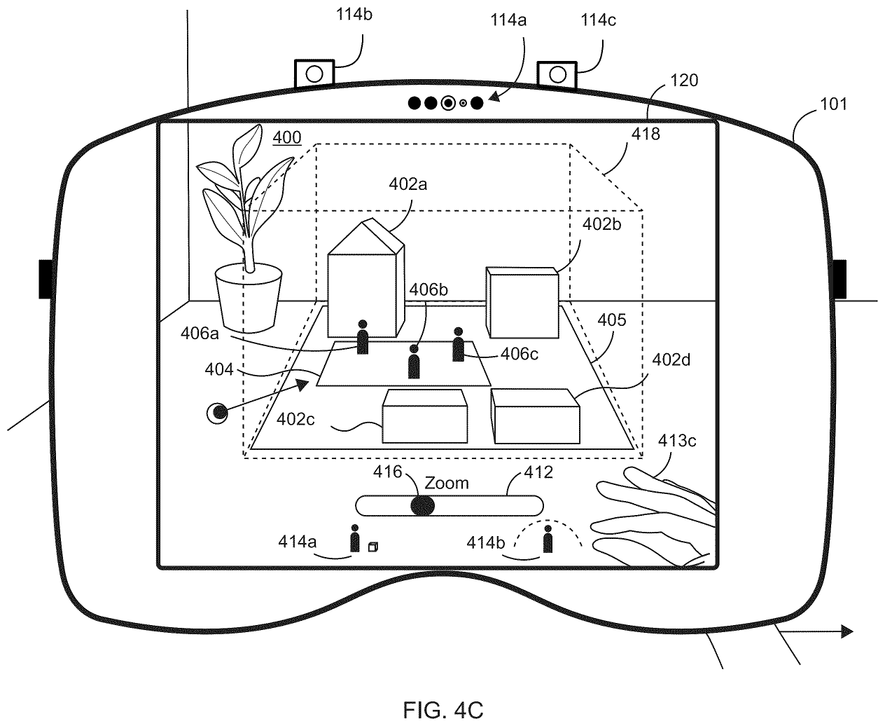

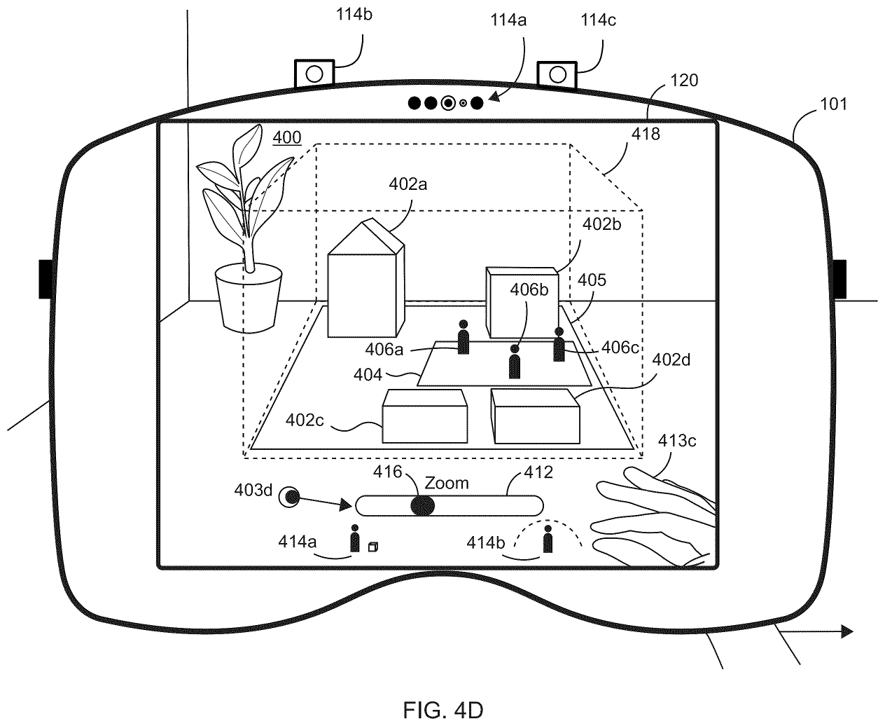

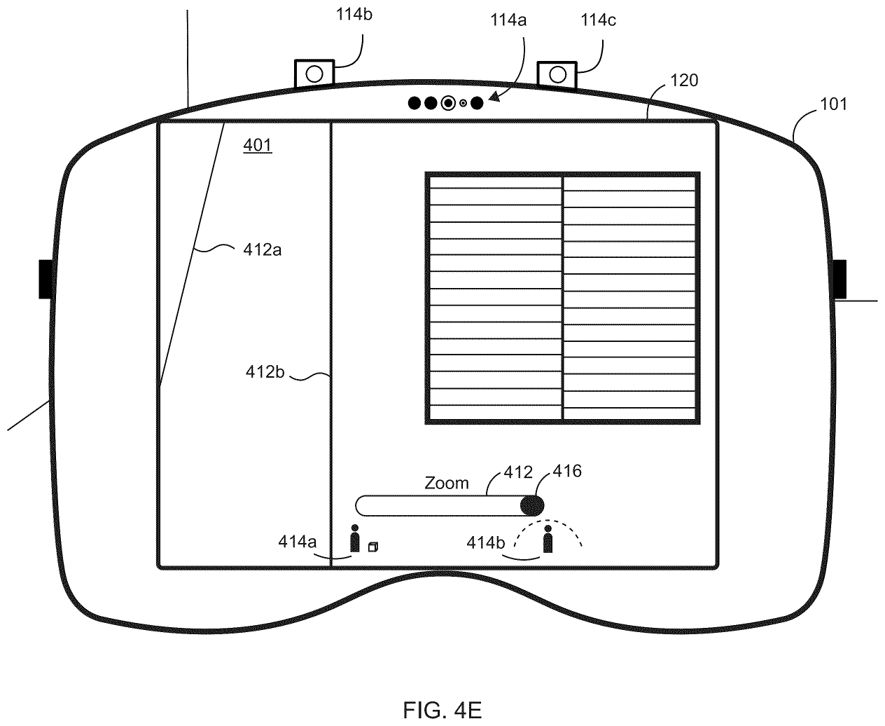

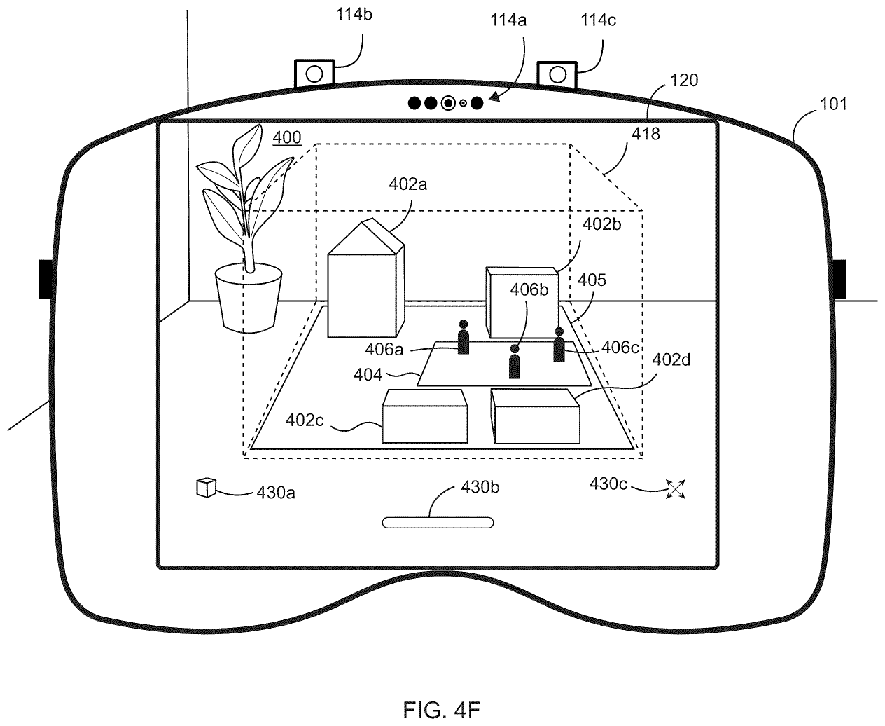

In some examples, the representations 306a through 306c of users are displayed within a representation 304 of a virtual stage of the virtual three-dimensional environment. In some examples, the virtual stage of the virtual three-dimensional environment is a region of the three-dimensional environment that corresponds to a predefined region in the three-dimensional environment. In some examples, the dimensions of the virtual stage correspond to (e.g., are the same as) the dimensions of the predefined region in the three-dimensional environment. In some examples, while the electronic device 101 displays the virtual three-dimensional environment, while the electronic device 101 is located within the predefined region of the physical environment, the electronic device 101 presents a more immersive experience than the experience while the electronic device 101 is located outside of the predefined region of the physical environment. For example, while the electronic device 101 is located within the predefined region of the physical environment, the electronic device 101 displays portions of the virtual three-dimensional environment within the virtual stage and beyond the virtual stage. In this example, while the electronic device 101 is located outside of the predefined region of the physical environment, the electronic device 101 displays portions of the virtual three-dimensional environment within the virtual stage and does not display portions of the virtual three-dimensional environment beyond the virtual stage. As described with reference to FIGS. 4C-4D, for example, the electronic device 101 is able to reposition the representation 304 of the virtual stage to change the portion of the virtual three-dimensional environment that corresponds to the predefined region of the physical environment.

In the example shown in FIG. 3A, the electronic device 101 that displays the model 305 uses a display configured to display three-dimensional content, such as a head-mounted display, to display the model 305. In some examples, the users corresponding to representations 306b and 306c are optionally also using three-dimensional displays, such as head-mounted displays. In some examples, while the electronic device 101 displays the model 305 without displaying the virtual three-dimensional environment, the other electronic devices also display the model 305 without displaying the three-dimensional environment. In some examples, while the electronic device 101 displays the model 305 without displaying the virtual three-dimensional environment, one or more of the other electronic devices displays a preview of the three-dimensional environment, such as in FIG. 3B, or displays the virtual three-dimensional environment with or without displaying the model 305, such as in FIG. 3C or FIG. 3D, respectively.

In some examples, electronic devices that are not in communication with a three-dimensional environment are able to display a representation of the three-dimensional model 305 in two dimensions. For example, an electronic device that uses a two-dimensional display to display content is in communication with the electronic device 101 and the electronic devices corresponding to representations 306b and 306c and has access to the model 305 and optionally the virtual three-dimensional environment. The electronic device that uses the two-dimensional display is optionally one of a computer, smartphone, tablet, media player, or a set-top box in communication with a two-dimensional display (e.g., a television screen). In some examples, such a device is able to view a two-dimensional representation of the model 305 and interact with the model in one or more ways described herein, such as zooming, panning, and/or rotating the model and/or updating the position of the virtual stage relative to the virtual three-dimensional environment by interacting with the representation 304 of the virtual stage included in the model 305. In some examples, when the device with the two-dimensional display updates the model 305, the electronic device 101 displays the model 305 updated in accordance with the updates made by the device with the two-dimensional display. In some examples, the device with the two-dimensional display can cause one or more of the devices with the three-dimensional displays to display the virtual three-dimensional environment. For example, in response to receiving a command from the device with the two-dimensional display to display the virtual three-dimensional environment, the electronic device 101 displays the virtual three-dimensional environment. In some examples, the device with the two-dimensional display can update the position of the virtual stage within the virtual three-dimensional environment by interacting with the representation 304 of the virtual stage included in model 305. For example, in response to receiving a command from the device with the two-dimensional display to update the position of the virtual stage with respect to the virtual three-dimensional environment, the electronic device 101 updates the position of the virtual stage with respect to the virtual three-dimensional environment, including updating the position of the representation 304 of the virtual stage within the model 305 in accordance with the updated position of the virtual stage with respect to the virtual three-dimensional environment.

As shown in FIG. 3A, in some examples, the electronic device 101 displays options 308a and 308b concurrently with the model 305. In response to detecting selection of option 308a, the electronic device 101 optionally displays a preview of the virtual three-dimensional environment, such as in FIG. 3B. In response to detecting selection of option 308b, the electronic device 101 optionally displays the virtual three-dimensional environment, such as in FIG. 3C. In FIG. 3A, the electronic device 101 detects selection of option 308a. For example, detecting selection includes detecting the gaze 303a of the user directed to option 308a while detecting the user perform a predefined gesture with hand 313a, such moving the hand into the pinch shape shown in FIG. 3A followed by moving the fingers touching in the pinch shape away from each other.

FIG. 3B illustrates the electronic device 101 displaying a preview of the virtual three-dimensional environment in accordance with some examples of the disclosure. In some examples, the electronic device 101 displays the preview of the virtual three-dimensional environment in response to receiving the input illustrated in FIG. 3A. The virtual three-dimensional environment 301 optionally corresponds to model 305.

In some examples, when displaying the preview of the virtual three-dimensional environment 301, the electronic device 101 presents a view of the virtual three-dimensional environment 301 through a portal. Outside of the portal, for example, the electronic device 101 presents a view of the physical environment 300 including a portion of the real object 314 that the electronic device 101 presented in FIG. 3A. In some examples, the preview of the virtual three-dimensional environment 301 is semi-translucent and portions of the physical environment are visible through the preview of the preview of the three-dimensional environment 301. In some examples, the preview of the virtual three-dimensional environment 301 is displayed with reduced rendering resolution compared to the rendering resolution with which the virtual three-dimensional environment 301 is displayed.

The electronic device 101 optionally displays the preview of the virtual three-dimensional environment 301 from the viewpoint of the user corresponding to the location of representation 306a in the model 305. For example, the model 305 includes representation 306a in front of a representation 302a of a respective virtual object, such as, for example, a respective building included in the virtual three-dimensional environment and the preview of the virtual three-dimensional environment 301 includes a view of virtual object 312a that corresponds to representation 306a. In some examples, if the viewpoint of the user had a different location, the location of the representation 306a and the viewpoint of the preview of the virtual three-dimensional environment 301 would be different, and would correspond to each other.

In some examples, the other electronic devices that have access to the virtual three-dimensional environment 301 concurrently display the preview of the three-dimensional environment 301 while the electronic device 101 displays the preview of the virtual three-dimensional environment 301. For example, the electronic device 101 transmits an indication to the other electronic devices to display the preview of the three-dimensional environment 301 in response to receiving the input shown in FIG. 3A.

In some examples, the other electronic devices display the preview of the virtual three-dimensional environment 301 at the same location relative to the physical environment as the location at which the electronic device 101 displays the preview of the virtual three-dimensional environment 301. For example, the preview of the virtual three-dimensional environment 301 is world-locked. In some examples, if the preview of the virtual three-dimensional environment 301 is world-locked, the position of the preview of the virtual three-dimensional environment 301 does not change in response to detecting movement of the electronic device 101 (or one of the other electronic devices with access to the virtual three-dimensional environment).

In some examples, the other electronic devices display the preview of the virtual three-dimensional environment 301 at different locations relative to the physical environment from the location at which the electronic device 101 displays the preview of the virtual three-dimensional environment 301. For example, the previews of the virtual three-dimensional environment 301 are world-locked. In some examples, if the previews of the virtual three-dimensional environment 301 are world-locked, the position of the previews of the virtual three-dimensional environment 301 do not change in response to detecting movement of the electronic device 101 (or one of the other electronic devices with access to the virtual three-dimensional environment). As another example, the previews of the virtual three-dimensional environment 301 are body-locked relative to the respective electronic device displaying the respective preview of the virtual three-dimensional environment 301. In some examples, if the previews of the virtual three-dimensional environment 301 are body-locked, the position of a respective preview of the virtual three-dimensional environment 301 changes in response to detecting movement of the respective electronic device 101 that displays the respective preview of the virtual three-dimensional environment 301.

In some examples, the other electronic devices with access to the virtual three-dimensional environment do not display the preview of the virtual three-dimensional environment unless and until they receive inputs requesting to display the preview of the virtual three-dimensional environment. Thus, in some examples, the other electronic devices do not necessarily display the preview of the virtual three-dimensional environment 301 merely because the electronic device 101 displays the preview of the virtual three-dimensional environment 301. In some examples in which the electronic devices display the preview of the virtual three-dimensional environment 301 independently, the electronic device 101 displays the preview of the virtual three-dimensional environment 301 in a world-locked manner as described above. In some examples in which the electronic devices display the preview of the virtual three-dimensional environment 301 independently, the electronic device 101 displays the preview of the virtual three-dimensional environment 301 in a body-locked manner as described above.

As shown in FIG. 3B, the electronic device 101 concurrently displays options 308c and 308b with the preview of the virtual three-dimensional environment 301. In some examples, in response to detecting selection of the option 308c, the electronic device 101 ceases display of the preview of the virtual three-dimensional environment 301 and maintains display of the model 305, such as in FIG. 3A. As shown in FIG. 3B, the electronic device 101 detects selection of option 308b, described in more detail above. In some examples, the electronic device 101 detects an air gesture directed to the option 308b, including the gaze 303b of the user being directed to the option 308b while the user performs the pinching hand gesture with hand 313b. In some examples, in response to detecting selection of the option 308b, the electronic device 101 displays the virtual three-dimensional environment 301, such as in FIG. 3C.

FIG. 3C illustrates the electronic device 101 displaying the virtual three-dimensional environment 301 concurrently with the model 305 according to some examples of the disclosure. In FIG. 3C, the electronic device 101 displays a portion of the virtual three-dimensional environment 301 that was displayed as the preview of the virtual three-dimensional environment 301 in FIG. 3B and displays an additional portion that was not included in the preview of the virtual three-dimensional environment 301 in FIG. 3B.

In FIG. 3C, the electronic device 101 displays the virtual three-dimensional environment 301 from the viewpoint of the user that corresponds to the position of representation 306a included in the model 305 as described above with reference to FIG. 3B. In some examples, if orientation and/or location of the electronic device 101 were to change, the electronic device 101 would present different portions of the virtual three-dimensional environment 301 in accordance with the updated viewpoint of the user updated in accordance with the updated orientation and/or location of the electronic device 101.

In some examples, displaying the three-dimensional environment 301 as shown in FIG. 3C is different from displaying the preview of the three-dimensional environment 301 as shown in FIG. 3B in that more portions of the virtual three-dimensional environment 301 are displayed than was the case when displaying the preview of the virtual three-dimensional environment 301. Additionally or alternatively, in some examples, displaying the three-dimensional environment 301 as shown in FIG. 3C is different from displaying the preview of the three-dimensional environment 301 as shown in FIG. 3B in that the electronic device 101 presents more portions of the physical environment concurrently with the preview of the three-dimensional environment 301, such as in FIG. 3B, than is the case while displaying the virtual three-dimensional environment 301, such as in FIG. 3C. Optionally, the electronic device 101 does not present portions of the physical environment when displaying the virtual three-dimensional environment 301. Additionally or alternatively, in some examples, displaying the three-dimensional environment 301 as shown in FIG. 3C is different from displaying the preview of the three-dimensional environment 301 as shown in FIG. 3B in that the three-dimensional environment 301 is world-locked to the physical environment, but the preview of the three-dimensional environment 301 is optionally body locked to the electronic device 101. Additionally or alternatively, in some examples, displaying the three-dimensional environment 301 as shown in FIG. 3C is different from displaying the preview of the three-dimensional environment 301 as shown in FIG. 3B in that the electronic device 101 displays the virtual three-dimensional environment 301, such as in FIG. 3C, with increased opacity compared to the opacity with which the electronic device 101 displays the preview of the virtual three-dimensional environment 301, such as in FIG. 3B. Additionally or alternatively, in some examples, displaying the three-dimensional environment 301 as shown in FIG. 3C is different from displaying the preview of the three-dimensional environment 301 as shown in FIG. 3B in that the electronic device 101 displays the virtual three-dimensional environment 301, such as in FIG. 3C, with increased rendering resolution compared to the rendering resolution with which the electronic device 101 displays the preview of the virtual three-dimensional environment 301, such as in FIG. 3B.

In some examples, when the electronic device 101 displays the virtual three-dimensional environment 301, the other electronic devices with access to the virtual three-dimensional environment 301 (e.g., the devices corresponding to representations 306b and 306c) also display the virtual three-dimensional environment 301. For example, in response to receiving the input requesting to display the virtual three-dimensional environment 301, such as in FIG. 3B, the electronic device 101 optionally transmits an indication to the other electronic devices to display the three-dimensional environment 301 from their respective viewpoints. In some examples, the electronic devices display the virtual three-dimensional environment 301 independently from each other. For example, while the electronic device 101 displays the virtual three-dimensional environment 301 as shown in FIG. 3C, one or more of the other electronic devices optionally does not display the virtual three-dimensional environment 301. In some examples, one or more other electronic devices display the preview of the virtual three-dimensional environment or forgo displaying the virtual three-dimensional environment 301 and forgo displaying the preview of the virtual three-dimensional environment 301 while the electronic device 101 displays the virtual three-dimensional environment 301.

In some examples, the model 305 is body-locked to the user. For example, the model 305 is body-locked to the user irrespective of whether the electronic device displays the model without displaying the virtual three-dimensional environment 301 or the preview of the virtual three-dimensional environment 301, concurrently with the virtual three-dimensional environment 301, or concurrently with the preview of the virtual three-dimensional environment 301. In some examples, the model 305 is world-locked. For example, the model 305 is world-locked irrespective of whether the electronic device displays the model without displaying the virtual three-dimensional environment 301 or the preview of the virtual three-dimensional environment 301, concurrently with the virtual three-dimensional environment 301, or concurrently with the preview of the virtual three-dimensional environment 301.

As shown in FIG. 3C, while displaying the virtual three-dimensional environment 301, the electronic device 101 displays the back option 308c and an option 309 to cease display of the model 305. In some examples, in response to detecting selection of the back option 308c, the electronic device 101 navigates back to the previous view, such as displaying the preview of the virtual three-dimensional environment 301 while maintaining display of the model 305 as shown in FIG. 3C. In some examples, in response to detecting selection of option 309, the electronic device 101 maintains display of the virtual three-dimensional environment 301 and ceases display of the model 305. In FIG. 3C, the electronic device 101 detects selection of the option 309, including detecting the gaze 303c of the user directed to the option 309 while the user performs the pinch gesture with their hand 313c. In response to the input shown in FIG. 3C, the electronic device 101 ceases display of the model 305 and maintains display of the virtual three-dimensional environment 301, such as in FIG. 3D.

FIG. 3D illustrates the electronic device 101 displaying the virtual three-dimensional environment 301 without displaying the model 305 according to some examples of the disclosure. In some examples, the electronic device 101 displays the three-dimensional environment 301 the same way described above with reference to FIG. 3C, except without displaying the model 305 shown in FIG. 3C. In some examples, in response to receiving an input (e.g., a voice input, an input received with a hardware input device, or selection of a displayed user interface element), the electronic device 101 resumes display of the model 305, such as in FIG. 3C.

In some examples, when the electronic device 101 ceases display of the model 305 in response to the input shown in FIG. 3C, the other electronic devices with access to the virtual three-dimensional environment 301 also cease display of the model 305. For example, in response to receiving the input illustrated in FIG. 3C, the electronic device 101 transmits a signal to the other electronic devices to cease display of the model 305. In some examples, the electronic devices display the model 305 independently. For example, other electronic devices continue to display the model 305 even when the electronic device 101 does not display the model 305.

Although the examples described above with reference to FIGS. 3A-3D include inputs shown in FIGS. 3A-3C, the disclosure is not limited to the inputs described above. In some examples, the electronic device 101 displays additional or alternative control elements that, when selected, cause the electronic device 101 to display the model 305, the preview of the virtual three-dimensional environment 301, and/or the virtual three-dimensional environment 301. Additionally or alternatively, in some examples, the electronic device 101 performs one or more actions described herein in response to a different type of input, such as a voice input, an input using a hardware input device (e.g., a keyboard, mouse, stylus, or touchscreen), and/or gesture inputs not directed to displayed elements.

FIGS. 4A-4F illustrate examples of the electronic device 101 interacting with the model 405 according to some examples of the disclosure. In FIG. 4A, the electronic device 101 displays a model 405 of a virtual three-dimensional environment that corresponds to the model 305 described above with reference to FIGS. 3A-3D. In the example of FIG. 4A, the electronic device 101 displays the model 405 concurrently with a view of the physical environment 400, but in some examples, the electronic device 101 performs one or more of the interactions with the model described herein as occurring while presenting the view of the physical environment 400 while displaying a preview of the virtual three-dimensional environment corresponding to model 405 or while displaying the virtual three-dimensional environment 401 corresponding to the model.

The model 405 optionally includes representations 402a through 402d of virtual objects corresponding to the representations 302a through 302d of virtual objects included in model 305. Additionally or alternative, the model 405 optionally includes a representation 404 of the virtual stage and representations 406a through 406c of the users with access to the virtual three-dimensional environment. For example, representation 406a corresponds to the user of the electronic device 101.

In FIG. 4A, the electronic device 101 displays the model 405 with a slider element 412 that controls a level of zoom of the model 405. For example, a first end 414a of the model corresponds to a minimum size of the model, such as the size shown in FIG. 4A, and a second end 414b of the model corresponds to displaying the virtual three-dimensional environment 401 at full size. The slider optionally includes an indicator 416 that indicates the current level of zoom and is interactive to change the level of zoom of the model 405. In some examples, the electronic device 101 displays the slider 412 concurrently with one or more of the control elements described above with reference to FIGS. 3A-3D. In some examples, the electronic device 101 displays the slider 412 without displaying one or more of the control elements described above with reference to FIGS. 3A-3D. For example, the electronic device 101 provides a mechanism for navigating between displaying the slider 412 and displaying one or more of the control elements shown in FIGS. 3A-3D, such as selectable navigation options or voice, gesture, or hardware input device inputs.

FIG. 4A further includes a bounding box 418 defining a volume in which the model 405 is displayed in some examples. The electronic device 101 optionally does not display bounding box 418 and bounding box 418 is merely shown for purposes of illustration. In some examples, when the electronic device 101 changes the size, orientation, and/or position of the model 405, the bounding box 418 remains the same size and in the same orientation shown in FIG. 4A, resulting in a portion of the model 405 being cut off at the boundary of the bounding box 418, such as in FIG. 4B. In some examples, when the electronic device 101 changes the size, orientation, and/or position of the model 405, the bounding box 418 changes size, orientation, and/or position in accordance with the change of the model 405 so that the model does not get cut off, as shown in FIG. 4C.

In FIG. 4A, the electronic device 101 receives an input to move the indicator 416 of the slider 412 to the right, including detecting the user pinch and move their hand 413a to the right while their gaze 403a is directed to the slider 512. For example, this interaction with the slider 412 corresponds to a request to display the model 405 zoomed in. In response to the input shown in FIG. 4A, or in response to another zoom input (e.g., a voice input, a gesture not directed to the slider 412, and/or an input received via a hardware input device), the electronic device 101 increases the scale of the model 405 to zoom the model 405 in, such as in FIG. 4B or FIG. 4C.

FIG. 4B is an example of the electronic device 101 displaying the model 405 zoomed in compared to the amount of zoom in FIG. 4A. For example, the electronic device 101 displays the model 405 as shown in FIG. 4B in response to receiving the zoom input described above with reference to FIG. 4A. In the example shown in FIG. 4B, the model 405 is cropped at the edges of the bounding box 418. For example, changing the level of zoom of the model 405 does not change the size of the model 405, or changes the size of the model 405 up to a maximum size defined by the bounding box 418 and does not increase the size of the model 405 beyond the size of the bounding box. In some examples, the electronic device 101 similarly crops the model 405 when panning and/or rotating the model (e.g., without zooming) in response to receiving inputs requesting these actions.

FIG. 4C is an example of the electronic device 101 zoomed in compared to the amount of zoom in FIG. 4A. For example, the electronic device 101 displays the model 405 as shown in FIG. 4C in response to receiving the zoom input described above with reference to FIG. 4A. In the example shown in FIG. 4C, the size of the bounding box 418 is increased to accommodate the zoomed-in, larger model 405. For example, changing the level of zoom of the model 405 changes the size of the model 405 and bounding box 418 in accordance with the amount of zoom. For example, if the model were displayed at a larger size in response to the zoom input, the bounding box 418 would also be larger, or if the model were displayed at a smaller size in response to the zoom input, the bounding box 418 would also be smaller. In some examples, the electronic device 101 similarly updates the bounding box 418 to accommodate the model 405 when panning and/or rotating the model (e.g., without zooming) in response to receiving inputs requesting these actions.

As shown in FIG. 4C, the electronic device 101 receives an input directed to the representation 404 of the virtual stage. The input optionally includes the gaze 403c of the user being directed to the representation 404 of the virtual stage and the user moving their hand 413c to the right while holding a pinch hand shape. In some examples, this input corresponds to a request to move the representation 404 of the virtual stage to the right. As shown in FIG. 4D, in response to the input shown in FIG. 4C, the electronic device 101 moves the representation 404 of the virtual stage and the representations 406a through 406c of the users in the virtual three-dimensional environment to the right within the model 405. As described herein, the electronic device 101 updates the viewpoints of the users corresponding to representations 406a through 406c in accordance with movement of the representations 406a through 406c within the model 405.

FIG. 4D is an example of the electronic device displaying the model 405 with the position of the representation 404 of the virtual stage and representations 406a through 406c of users moved in accordance with the input described above with reference to FIG. 4C. As shown in FIG. 4D, for example, the electronic device 101 displays the representation of the virtual stage in FIG. 4D to the right of the position of the representation 404 of the virtual stage in FIG. 4C. In some examples, when the electronic device 101 moves the representation 404 of the virtual stage, the electronic device 101 maintains the spatial relationship of the representations 406a through 406c of users relative to one another and to the representation 404 of the virtual stage. As described herein, in some examples, when the electronic device 101 moves the representations 406a through 406c of the users within the model 405, the electronic device 101 updates the viewpoints of the users in the virtual three-dimensional environment in accordance with the updated positions of the representations 406a through 406c within the model 405.

In FIG. 4D, the electronic device 101 receives an input directed to the slider element 412 that includes detecting the gaze 403d of the user directed to the slider element 412 and/or the indication 416 of the slider element and movement of hand 413a to the right while in the pinch hand shape. In some examples, this input corresponds to a request to move the indicator 416 of slider element 412 to the right to the maximum position of the slider element 412, causing the electronic device 101 to display the virtual three-dimensional environment, as shown in FIG. 4E.

FIG. 4E is an example of the electronic device 101 displaying the virtual three-dimensional environment 401 in response to receiving the input shown in FIG. 4D. In some examples, the electronic device 101 displays the virtual three-dimensional environment 401 from the viewpoint of the user represented by representation 406a in the model 405 in FIG. 4D. For example, the view of the virtual three-dimensional environment 401 in FIG. 4E includes virtual objects 412a and 412b (e.g., buildings) that correspond to representations 402a and 402b in the model 405 in FIG. 4D.

FIG. 4F is an example of the electronic device 101 displaying a zooming control element 430a and a panning control element 430c concurrently with the model 405. Displaying the zooming control element 430a and panning control element 430c in proximity to the model 405 as shown in FIG. 4F makes these elements easier for the user to access and enhances user experience. In some examples, the electronic device 101 displays the zooming control element 430a and the panning control element 430c at the same height in the three-dimensional environment 400 as the model 405, such as in the same horizontal plane as the base of the model 405. Additionally or alternatively, in some examples, the electronic device 101 displays a movement control element 430b concurrently with the model 405. In some examples, the electronic device 101 receives inputs directed to control elements 430a, 430b, and/or 430c based on detecting the attention (e.g., including gaze) of the user directed to a respective control element while detecting the user perform a hand gesture associated with selection, such as a pinch gesture, an air tap gesture, and/or movement of the hand in a pinch hand shape. In some examples, in response to detecting an input selecting a respective control element 430a, 430b, and/or 430c, the electronic device 101 modifies display of the model 405 in response to detecting further input in a manner associated with the selected control element.

For example, in response to detecting an input directed to the zooming control element 430a, the electronic device 101 zooms the model 405 in response to detecting further input in a manner similar to the manner(s) of zooming the model 405 described above. For example, the electronic device 101 detects the user attention directed to the zooming control element 430a and the user make a pinch hand shape. In response to detecting movement of the hand in the pinch hand shape while holding the pinch hand shape, the electronic device 101 optionally adjusts the level of zoom of the model 405 in accordance with the movement of the hand. For example, a first direction of movement corresponds to zooming the model 405 in and a second direction (e.g., opposite direction) of movement corresponds to zooming the model 405 out. Additionally or alternatively, for example, the electronic device 101 adjusts the level of zoom by a magnitude that corresponds to the magnitude of movement of the hand, such as a speed, distance, and/or duration of movement. Additionally or alternatively, in some examples, the electronic device 101 adjusts the level of zoom in response to detecting a gesture performed with a hand of the user while the user maintains the pinch hand shape with their other hand after making the pinch hand shape while the attention of the user was directed to the zooming control element 430a. Additionally or alternatively, in some examples, the electronic device 101 adjusts the level of zoom in response to detecting a gesture performed with a hand of the user after the user makes the pinch gesture while the attention of the user is directed to the zooming control element 430a. In some examples, the zooming the electronic device 101 performs in response to the input directed to the zooming control element 430a has one or more characteristics of other zooming operations described herein, such as clipping or not clipping the model 405 within bounding box 418 and/or causing the presentation of the model 405 at other electronic devices in communication with the electronic device to update or not update.

In some examples, in response to detecting an input directed to the movement control element 430b, the electronic device 101 moves the model 405 relative to the three-dimensional environment 400. For example, the electronic device 101 detects the user make a pinch hand shape while the attention of the user is directed to the movement control element 430b, followed by movement of the hand in the pinch hand shape. In this example, the electronic device 101 moves the model 405 and, optionally control elements 430a through 430b, by an amount and direction corresponding to the amount and direction of the movement of the hand in the pinch hand shape. For example, when moving the model 405, the electronic device 101 maintains the placement of the control elements 430a through 403c relative to the model 405.

In some examples, in response to detecting an input directed to the panning control element 430c, the electronic device 101 pans the model 405 in response to detecting further input. In some examples, panning the model changes which portion of the model 405 the electronic device 101 displays in bounding box 418 without changing a position of the bounding box 418 in the three-dimensional environment 400. For example, the electronic device 101 detects the user attention directed to the panning control element 430c and the user make a pinch hand shape. In response to detecting movement of the hand in the pinch hand shape while holding the pinch hand shape, the electronic device 101 optionally pans the model 405 in a direction and by an amount in accordance with the direction and amount movement of the hand. Additionally or alternatively, in some examples, the electronic device 101 pans the model 405 in response to detecting a gesture performed with a hand of the user while the user maintains the pinch hand shape with their other hand after making the pinch hand shape while the attention of the user was directed to the panning control element 430c. Additionally or alternatively, in some examples, the electronic device 101 pans the model 405 in response to detecting a gesture performed with a hand of the user while the user after the user make the pinch gesture while the attention of the user is directed to the panning control element 430c. In some examples, the panning the electronic device 101 performs in response to the input directed to the panning control element 430c causes or does not cause the presentation of the model 405 at other electronic devices in communication with the electronic device to update or not update, similar to the manner described above with respect to zooming.

As described above, in some examples, when the electronic device 101 displays the virtual three-dimensional environment 401, the other electronic devices also display the virtual three-dimensional environment from their respective viewpoints. As described above, in some examples, when the electronic device 101 displays the virtual three-dimensional environment 401, the other electronic devices do not necessarily display the virtual three-dimensional environment.

Likewise, in some examples, when the electronic device 101 updates the model 405, such as panning, zooming, and/or rotating the model 405 as described above with reference to FIGS. 4A-4F, the other electronic devices update the model 405 in the same manner. In some examples, when the electronic device 101 updates the model 405, such as panning, zooming, and/or rotating the model 405 as described above with reference to FIGS. 4A-4F, the other electronic devices do not update the model 405 in the same manner.

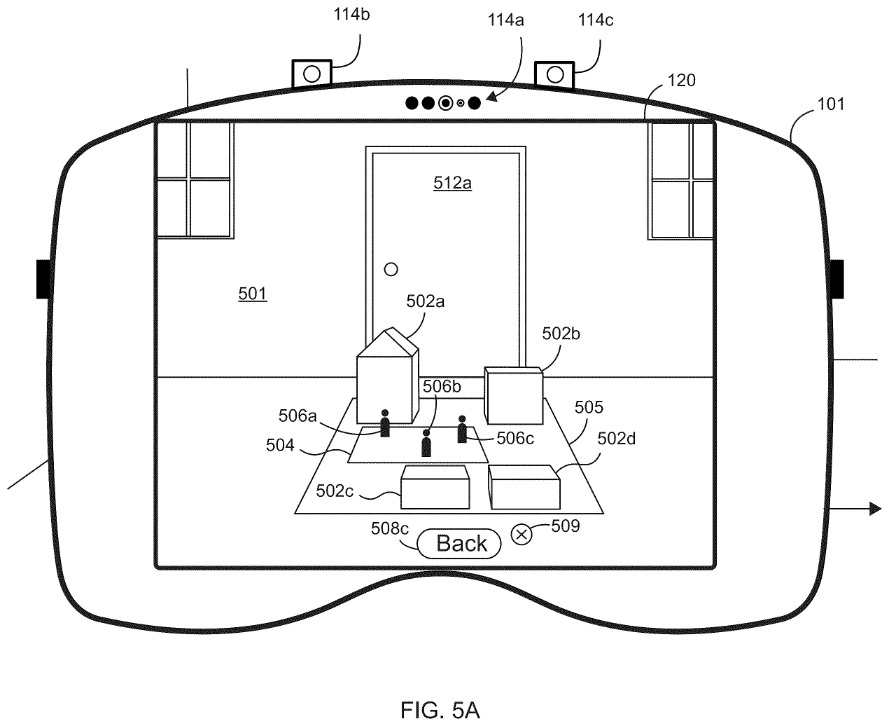

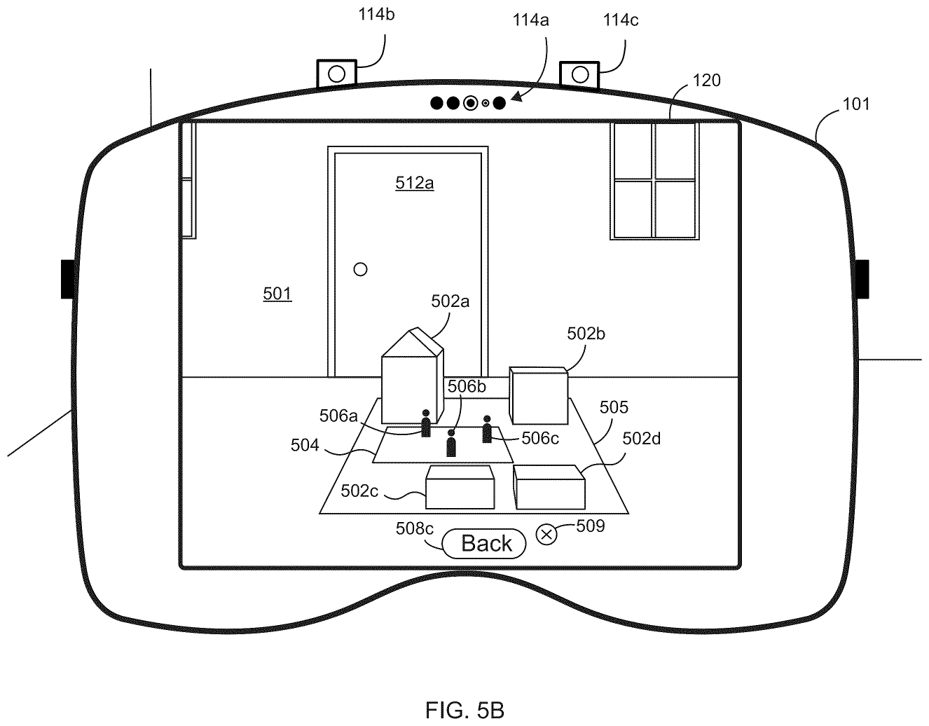

FIGS. 5A-5B illustrate updating the viewpoint of a user in a virtual three-dimensional environment 501 and the position of a representation 506a of the user in a model 505 of the virtual three-dimensional environment 501 in response to movement of the electronic device 101 in the physical environment according to some examples of the disclosure. In FIG. 5A, the electronic device 101 concurrently displays a view of a virtual three-dimensional environment 501 and a model 505 of the virtual three-dimensional environment. For example, the view of the virtual three-dimensional environment 501 includes a view of a virtual object 512a (e.g., a building). In the example of FIG. 5A, the model 505 is similar to other models of virtual three-dimensional environments described herein, including representations 502a through 502d of virtual objects (e.g., buildings) of the environment, a representation 504 of a virtual stage, and representations 506a through 506c of users with access to the three-dimensional environment 501 displayed at locations corresponding to the viewpoints of the users in the virtual three-dimensional environment 501. In some examples, the electronic device 101 concurrently displays an option 508c to navigate back to a previously displayed user interface and an option 509 to cease display of the model 505 concurrently with the model 505 and the three-dimensional environment 501.

As shown in FIG. 5A, the electronic device 101 detects movement of the electronic device 101 and/or display 120 to the right. For example, the electronic device 101 includes a head-mounted display 120 and the electronic device 101 detects movement of the user of the electronic device 101 while the user is wearing the head-mounted display. As shown in FIG. 5B, in response to detecting movement of the electronic device 101 and/or display 120, the electronic device 101 updates the viewpoint of the user in the virtual three-dimensional environment 501 and the position of the representation 506a of the user in the model in accordance with the movement of the electronic device 101 and/or display.

FIG. 5B illustrates the electronic device 101 displaying the updated model 505 concurrently with the virtual three-dimensional environment 501 from the updated viewpoint of the user according to some examples of the disclosure. For example, in FIG. 5B, the view of the virtual three-dimensional environment 501 is shifted in accordance with the movement of the electronic device 101 and/or display 120 in FIG. 5A. For example, because the viewpoint of the user moved to the right, the object 512a (e.g., building) appears to have shifted to the left. Additionally, as shown in FIG. 5B, the electronic device 101 updates the position of the representation 506a of the use of the electronic device 101 to move the representation 506a to the right in accordance with the movement of the electronic device 101 and/or the display 120 in FIG. 5A, for example. In some examples, moving the representation 506a updates the spatial relationship of the representations 506a through 506c so that the spatial representation of the representation 506a through 506c corresponds to the updated spatial relationship of the users in the physical environment. In some examples, if a different electronic device or the display of a different electronic device corresponding to representation 506b or 506c were to move in the physical environment, then the electronic device 101 would update the location of the representation 506b or 506c in the model 505 in accordance with the movement.

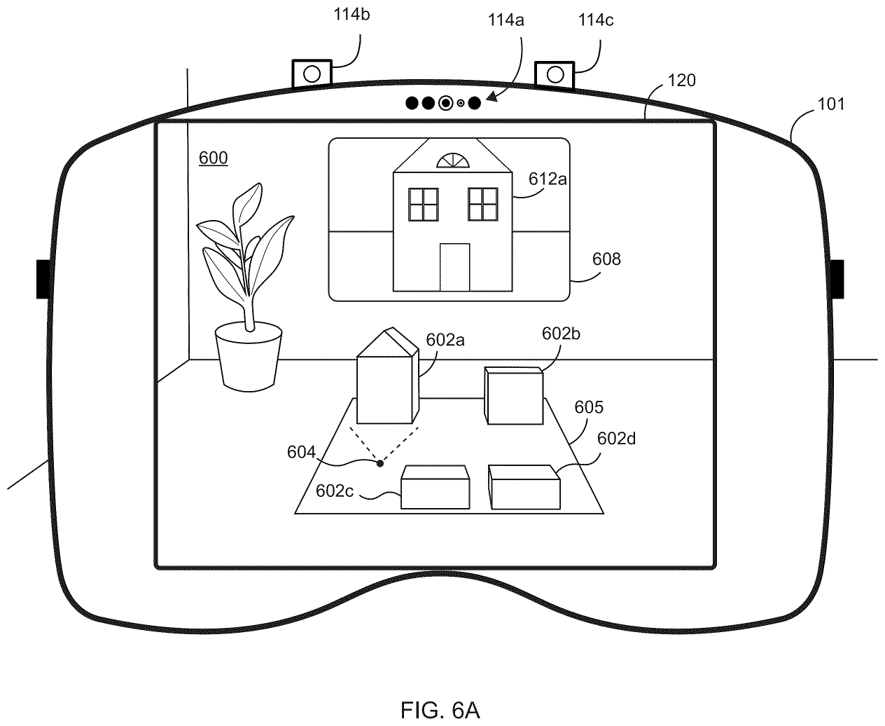

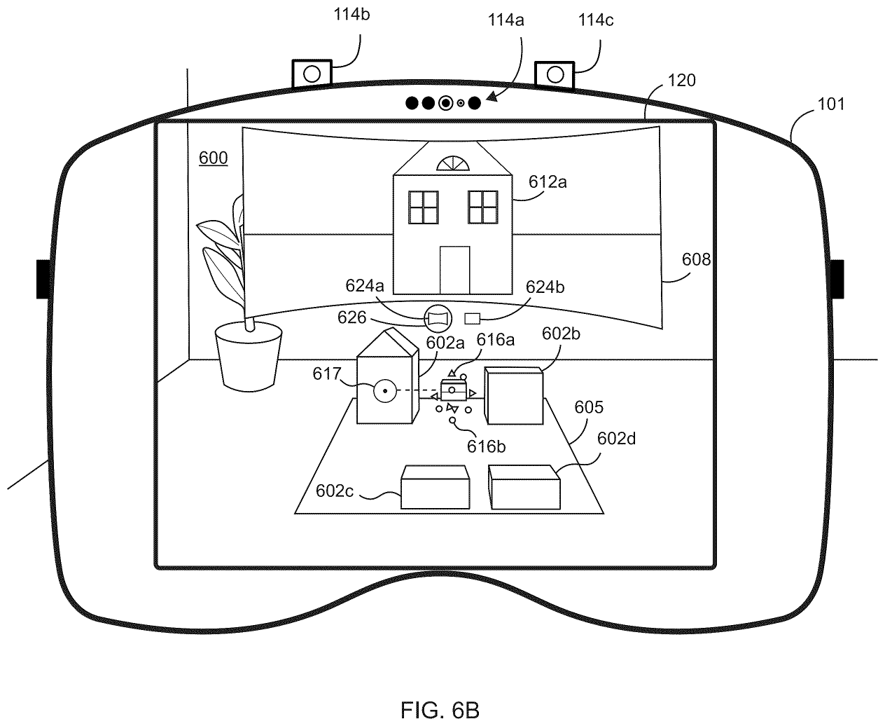

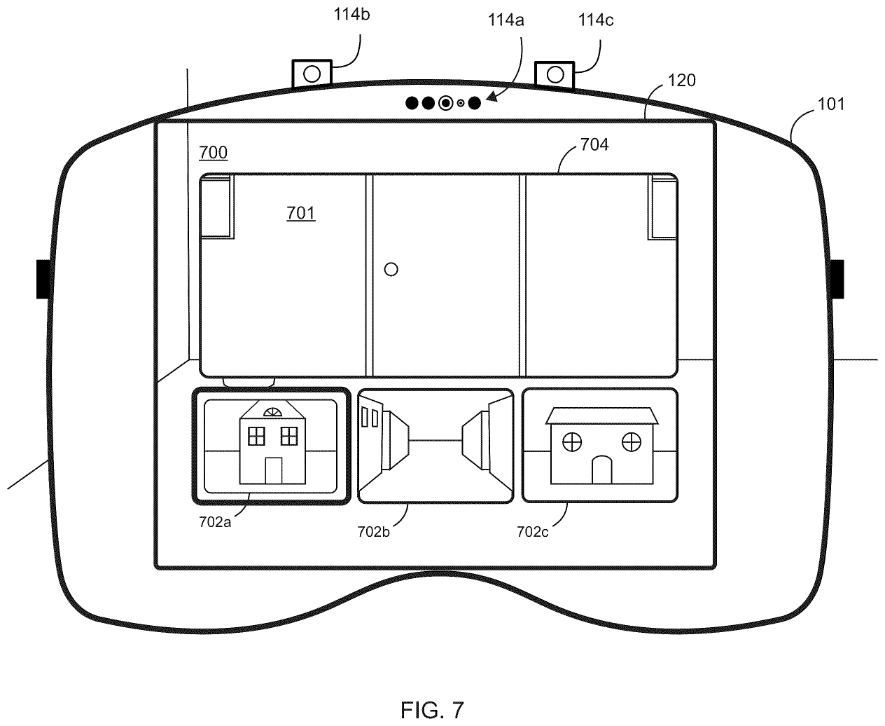

FIG. 6A illustrates the electronic device 101 displaying a two-dimensional image 608 of the virtual three-dimensional environment concurrently with a model 605 of the virtual three-dimensional environment according to some examples of the disclosure. In some examples, the model 605 is similar to other models of virtual three-dimensional environments described herein. For example, the model 605 includes representations 602a through 602d of virtual objects (e.g., buildings) in the virtual three-dimensional environment. In some examples, the model 605 includes an indication of a virtual camera 604 in the three-dimensional environment that illustrates the viewpoint of the three-dimensional environment from which a two-dimensional image 608 of the virtual three-dimensional environment could be taken. For example, the model 605 includes the indication of the virtual camera 604 facing a representation 602a of a respective virtual object and the image 608 includes an image 612a of the virtual object. In some examples, the virtual camera 604 is not associated with a viewpoint of a user in the three-dimensional environment. In some examples, in response to an input to update the position and/or orientation of the virtual camera 604, the electronic device 101 updates the virtual camera 604 in the model 605 and displays another image in place of image 608 that corresponds to the viewpoint indicated by the virtual camera 604. In some examples, the electronic device 101 is able to save one or more virtual images of the virtual three-dimensional environment and their associated viewpoints, as described below with reference to FIG. 7.

FIG. 6B illustrates the electronic device 101 displaying a three-dimensional image 618 captured by a virtual camera 614 positioned and oriented in model 605 according to some examples of the disclosure. As described above with reference to FIG. 6A, the viewpoint of image 618 corresponds to the viewpoint of the virtual camera element 614 representing the viewpoint in the model 605.

In some examples, the electronic device 101 produces three-dimensional image(s) of the virtual three-dimensional environment represented by model 605 using the virtual camera 614. For example, the electronic device 101 displays the image 618 as a portal into the virtual three-dimensional environment represented by the model 605. Optionally, one or more objects included in the image 618 extend beyond the borders of the image 618 to simulate one or more objects “popping out” of the image 618 towards the viewer. For example, portions of the objects that extend beyond the border in some dimensions, such as height and/or width, are cropped from the image 618, but portions of objects that extend beyond the border in other dimensions, such as depth, extend beyond the border of the image 618. As another example, some types of objects, such as objects designated as being part of the set or background of the image 618 are cropped to fit in the border of the image 618, but other objects, such as objects designated as a subject of the image 618, are displayed extending beyond the borders of the image 618.

In some examples, the electronic device 101 is able to toggle presenting the image captured with the virtual camera 605 as a three-dimensional image and as a two-dimensional image using options 624a and 624b. For example, in response to detecting selection of option 624b while displaying the image as a three-dimensional image, as shown in FIG. 6B with three-dimensional image 618, the electronic device 101 would cease displaying the three-dimensional image 618 and display a two-dimensional image instead, similar to two-dimensional image 608 in FIG. 6A. As another example, in response to detecting selection of option 624a while displaying the image as a two-dimensional image similar to two-dimensional image 608 in FIG. 6A, the electronic device 101 would cease displaying the two-dimensional image and display a three-dimensional image instead, such as the three-dimensional image 618 shown in FIG. 6B. As shown in FIG. 6B, the electronic device 101 indicates that the image 618 is three-dimensional by displaying option 624a with indication 626, but in some examples, other indications are possible, such as changing the size, color, line style, and/or translucency of the option 624a when it is selected.

In some examples, the electronic device 101 uses the virtual camera 614 to capture still images as described above with reference to FIG. 6A. The electronic device 101 optionally updates the viewpoint of the virtual camera 614 as described below to capture images of the virtual three-dimensional environment corresponding to model 605 from those updated viewpoints. In some examples, the electronic device 101 uses the virtual camera 614 to capture video images that include movement of the viewpoint of the virtual camera 614, and the corresponding movement of the viewpoint of the video image. For example, the virtual camera 614 simulates a camera panning, rotating, or otherwise moving through the virtual three-dimensional environment represented by the model 605. As shown in FIG. 6B, in some examples, the virtual camera is a three-dimensional element that indicates the position and orientation of the viewpoint corresponding to image 618.

In some examples, the electronic device 101 updates the viewpoint of the image 618 in response to receiving one or more inputs directed to control elements 616a, 616b and/or 617. For example, in response to detecting selection of one of control elements 616a, the electronic device 101 pans the virtual camera 614 relative to the model 605 and updates the viewpoint of the video image 618 accordingly, optionally without rotating the virtual camera 614. As another example, in response to detecting selection of one of control elements 616b, the electronic device 101 rotates the virtual camera 614 relative to the model 605 and updates the viewpoint of the video image 618 accordingly, optionally without panning the virtual camera 614. As another example, in response to detecting selection and movement of control element 617, the electronic device 101 rotates the virtual camera 614 to capture a portion of the virtual three-dimensional environment corresponding to the location in the model 605 including the control element 617. In some examples, capturing movement of the camera includes capturing the speed and amount of movement of the virtual camera 614, as well as capturing the duration(s) of time for which the viewpoint of the virtual camera 614 is still. In some examples, the electronic device 101 presents the video image 618 with a moving viewpoint in real-time while receiving the input(s) controlling the viewpoint of the virtual camera 614. In some examples, the electronic device 101 records the sequence of inputs moving the virtual camera 614, then captures the video image 618 after receiving the inputs. For example, the electronic device 101 re-uses sequences of movement of the virtual camera 614 to generate multiple video images, optionally with different starting viewpoints in the virtual three-dimensional environment represented by the model 605.

As another example, the electronic device 101 optionally moves the virtual camera 614 in accordance with movement of a real camera that was used to capture real video of a physical environment. In some examples, the real video of the physical environment is three-dimensional (e.g., stereo) video. The electronic device 101 optionally combines the video of the virtual three-dimensional environment represented by the model 605 with the real video of the physical environment. For example, the electronic device 101 produces a video that includes a set, background content, and/or one or more virtual objects captured using virtual camera 614 in the virtual three-dimensional environment of the model 605 and footage of one or more real objects included in the real video.

FIG. 7 illustrates the electronic device 101 displaying a plurality of virtual images 702a through 702c of the virtual three-dimensional environment concurrently with a view 704 of the virtual three-dimensional environment 701 corresponding to one of the images 702a according to some examples of the disclosure. In some examples, the images 702a through 702c are two-dimensional images and the view 704 into the virtual three-dimensional environment 701 presents a three-dimensional view of a portion of the virtual three-dimensional environment 701. In some examples, the images 702a through 702c are captured using a virtual camera, such as the virtual camera described above with reference to FIG. 6. In some examples, the electronic device 101 displays the virtual images 702a through 702c and the view 704 of the virtual three-dimensional environment 701 while concurrently presenting portions of the physical environment 700, as shown in FIG. 7. In some examples, in response to detecting selection of a different image, such as image 702b or image 702c, the electronic device 101 displays a preview of the virtual three-dimensional environment 701 from the viewpoint corresponding to the selected image instead of displaying the view 704 corresponding to image 702a, as in FIG. 7.

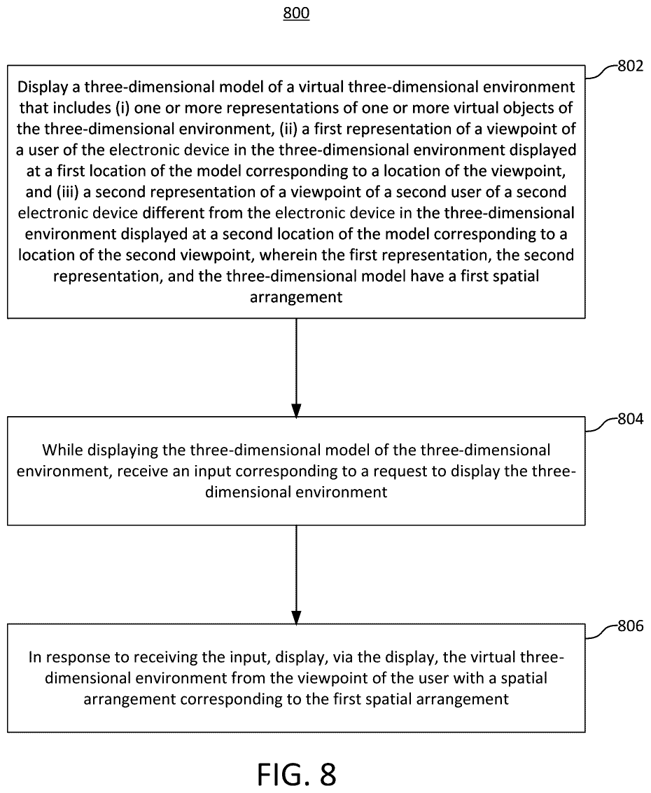

FIG. 8 is a flow chart of a method 800 of displaying a model of a virtual three-dimensional environment according to some examples of the disclosure. In some examples, instructions for executing method 800 are stored using a (e.g., non-transitory) computer readable storage medium, and executing the instructions causes an electronic device (e.g., electronic device 101 or electronic device 201) to perform method 800.

At 802, in some examples, the electronic device displays a three-dimensional model of a virtual three-dimensional environment that includes (i) one or more representations of one or more virtual objects of the three-dimensional environment, (ii) a first representation of a viewpoint of a user of the electronic device in the three-dimensional environment displayed at a first location of the model corresponding to a location of the viewpoint, and (iii) a second representation of a viewpoint of a second user of a second electronic device different from the electronic device in the three-dimensional environment displayed at a second location of the model corresponding to a location of the second viewpoint, wherein the first representation, the second representation, and the three-dimensional model have a first spatial arrangement. At 804, in some examples, while displaying the three-dimensional model of the three-dimensional environment, the electronic device receives an input corresponding to a request to display the three-dimensional environment. At 806, in some examples, in response to receiving the input, the electronic device displays, via the display, the virtual three-dimensional environment from the viewpoint of the user with a spatial arrangement corresponding to the first spatial arrangement

Additionally or alternatively, in some examples, method 800 includes, while displaying the three-dimensional model, receiving a second input corresponding to a request to move the first representation and the second representation relative to the three-dimensional model; in response to receiving the second input, updating the three-dimensional model so that the first representation and the second representation have a second spatial arrangement different from the first spatial arrangement relative to the three-dimensional environment in accordance with the second input; and receiving a third input corresponding to a request to display the three-dimensional environment from the viewpoint of the second user; and in response to receiving the third input, displaying, via the display, the virtual three-dimensional environment from the viewpoint of the user with a spatial arrangement corresponding to the second spatial arrangement. Additionally or alternatively, in some examples in accordance with a determination that the input corresponding to the request to display the three-dimensional environment is directed to an option to preview the three-dimensional environment, displaying the three-dimensional environment includes displaying a partially-rendered version of a portion of the three-dimensional environment. Additionally or alternatively, in some examples in accordance with a determination that the input corresponding to the request to display the three-dimensional environment is directed to an option to fully display the three-dimensional environment, displaying the three-dimensional environment includes displaying a fully-rendered version of the three-dimensional environment. Additionally or alternatively, in some examples method 800 includes displaying, via the display, one or more two-dimensional representations of one or more saved views of the three-dimensional environment, wherein the one or more the two-dimensional representations of the one or more saved views include one or more two-dimensional renderings of the three-dimensional environment from one or more viewpoints corresponding to the one or more saved views. Additionally or alternatively, in some examples method 800 includes while displaying the one or more two-dimensional representations of the one or more saved views receiving, via the one or more input devices, a second input selecting a respective two-dimensional representation of a respective saved view included in the one or more two-dimensional representations of the one or more saved views; and in response to receiving the second input, displaying a portion of three-dimensional environment from a viewpoint of the respective saved view. Additionally or alternatively, in some examples displaying the three-dimensional model includes displaying the three-dimensional model within a predefined three-dimensional volume, and the method 800 further comprises while displaying the three-dimensional model in the predefined three-dimensional volume: receiving, via the one or more input devices, a second input corresponding to a request to change a position and/or orientation and/or size of the three-dimensional model relative to the predefined three-dimensional volume; and in response to receiving the second input: updating the position and/or the orientation and/or the size of the three-dimensional model relative to the predefined three-dimensional volume in accordance with the second input, including ceasing display of a portion of the three-dimensional model that extends beyond the predefined three-dimensional volume. Additionally or alternatively, in some examples displaying the three-dimensional model includes displaying the three-dimensional model within a predefined three-dimensional volume, and the method further comprises: while displaying the three-dimensional model in the predefined three-dimensional volume: receiving, via the one or more input devices, a second input corresponding to a request to change a position and/or orientation and/or size of the three-dimensional model relative to the three-dimensional environment; and in response to receiving the second input: updating the position and/or the orientation and/or the size of the three-dimensional model relative to the three-dimensional environment in accordance with the second input; and updating the predefined three-dimensional volume in accordance with updating the position and/or the orientation and/or the size of the three-dimensional model. Additionally or alternatively, in some examples the method 800 includes while displaying the three-dimensional model, displaying, via the display, a two-dimensional representation of a respective view of the three-dimensional environment, wherein the three-dimensional model includes a third representation of the respective view that has a location and orientation relative to the model that corresponds to a location and orientation of the respective view relative to the three-dimensional environment. Additionally or alternatively, in some examples method 800 includes while displaying the three-dimensional model: displaying, via the display, a slider control element that controls a scale of the three-dimensional model; and in accordance with a determination that a current value of the slider control element is a minimum value concurrently displaying, using the display, the three-dimensional model and a view of a physical environment of the electronic device. Additionally or alternatively, in some examples method 800 includes, while displaying the three-dimensional model: in response to receiving a second input, displaying, via the display, the three-dimensional model without displaying the virtual three-dimensional environment at a full size; and in response to receiving a third input, displaying, via the display, the three-dimensional model concurrently with the virtual three-dimensional environment at the full size. Additionally or alternatively, in some examples method 800 includes while displaying the three-dimensional model, receiving a fourth input; and in response to receiving the fourth input: displaying, via the display, the three-dimensional environment at the full size; and ceasing display of the three-dimensional model. Additionally or alternatively, in some examples method 800 includes while concurrently displaying the three-dimensional model concurrently with the virtual three-dimensional environment at the full size: in accordance with a determination that one or more first criteria are satisfied, prioritizing rendering the three-dimensional environment over rendering the three-dimensional model; and in accordance with a determination that one or more second criteria are satisfied different from the one or more first criteria, prioritizing rendering the three-dimensional model over rendering the three-dimensional environment. Additionally or alternatively, in some examples the first spatial arrangement of the first representation, the second representation, and the three-dimensional model corresponds to a spatial arrangement of the user of the electronic device, the second user of the second electronic device, and a physical environment of the electronic device. Additionally or alternatively, in some examples method 800 includes while displaying the three-dimensional model, detecting the spatial arrangement of the user of the electronic device, the second user of the second electronic device, and the physical environment of the electronic device change to a second spatial arrangement; and in response to detecting the spatial arrangement of the user of the electronic device, the second user of the second electronic device, and the physical environment of the electronic device change to the second spatial arrangement: updating the model to include the first representation and the second representation in a spatial arrangement that is different from the first spatial arrangement and corresponds to the second spatial arrangement of the user of the electronic device, the second user of the second electronic device, and the physical environment of the electronic device.

Some examples of the disclosure are directed to a method comprising at an electronic device in communication with a display concurrently displaying, using the display: a three-dimensional model of a virtual three-dimensional environment including a representation of a viewpoint in the virtual three-dimensional environment; and content including an image of the virtual three-dimensional environment from the viewpoint, wherein in accordance with a determination that the viewpoint in the virtual three-dimensional environment is a first viewpoint, the image is a first image from the first viewpoint; and in accordance with a determination that the viewpoint in the virtual three-dimensional environment is a second viewpoint different from the first viewpoint, the image is a second image from the second viewpoint. Additionally or alternatively, in some examples, the method further includes in accordance with a determination that the image is displayed as a two-dimensional image, displaying, using the display, a selectable option that, when selected, causes the electronic device to display the image as a three-dimensional image; and in accordance with a determination that the image is displayed as a three-dimensional image, displaying, using the display, a selectable option that, when selected, causes the electronic device to display the image as the two-dimensional image. Additionally or alternatively, in some examples, the content includes video content that includes movement of the viewpoint in the virtual three-dimensional environment. Additionally or alternatively, in some examples, the method further includes capturing the video content, including: while displaying the video content: receiving, via one or more input devices in communication with the electronic device, one or more inputs updating the viewpoint in the three-dimensional environment; and in response to receiving the one or more inputs, updating the viewpoint in the three-dimensional environment in accordance with the one or more inputs and updating the video in accordance with the viewpoint. Additionally or alternatively, in some examples, the method further includes prior to capturing the video content, receiving, via one or more input devices in communication with the electronic device, one or more inputs defining a sequence of movement of the viewpoint in the virtual three-dimensional environment; and after receiving the one or more inputs, capturing the video content, including updating the viewpoint in the three-dimensional environment in accordance with the one or more inputs and updating the video in accordance with the viewpoint. Additionally or alternatively, in some examples, the method further includes displaying, using the display, a plurality of control elements associated with the viewpoint in the virtual three-dimensional environment; and receiving, via one or more input devices in communication with the electronic device, one or more inputs directed to the plurality of control elements, wherein the movement of the viewpoint in the three-dimensional environment in the video content is based on the one or more inputs directed to the plurality of control elements. Additionally or alternatively, in some examples, the movement of the viewpoint in the virtual three-dimensional environment in the video content is based on movement of a physical camera that captured real video footage. Additionally or alternatively, in some examples, the method further includes presenting, using the display, a second video content that concurrently includes a portion of the video content of the virtual three-dimensional environment and a portion of the real video footage. Additionally or alternatively, in some examples, the method further includes playing the video content; and while playing the video content, displaying movement of the representation of the viewpoint in the virtual three-dimensional environment in the three-dimensional model synchronized with playback of the video content.

Some examples of the disclosure are directed to an electronic device comprising: memory; and one or more processors coupled to the memory and configured to perform a method comprising: concurrently displaying, using a display in communication with the electronic device a three-dimensional model of a virtual three-dimensional environment including a representation of a viewpoint in the virtual three-dimensional environment; and content including an image of the virtual three-dimensional environment from the viewpoint, wherein in accordance with a determination that the viewpoint in the virtual three-dimensional environment is a first viewpoint, the image is a first image from the first viewpoint; and in accordance with a determination that the viewpoint in the virtual three-dimensional environment is a second viewpoint different from the first viewpoint, the image is a second image from the second viewpoint. Additionally or alternatively, in some examples, the method further includes in accordance with a determination that the image is displayed as a two-dimensional image, displaying, using the display, a selectable option that, when selected, causes the electronic device to display the image as a three-dimensional image; and in accordance with a determination that the image is displayed as a three-dimensional image, displaying, using the display, a selectable option that, when selected, causes the electronic device to display the image as the two-dimensional image. Additionally or alternatively, in some examples, the content includes video content that includes movement of the viewpoint in the virtual three-dimensional environment. Additionally or alternatively, in some examples, the method further includes capturing the video content, including: while displaying the video content: receiving, via one or more input devices in communication with the electronic device, one or more inputs updating the viewpoint in the three-dimensional environment; and in response to receiving the one or more inputs, updating the viewpoint in the three-dimensional environment in accordance with the one or more inputs and updating the video in accordance with the viewpoint. Additionally or alternatively, in some examples, the method further includes prior to capturing the video content, receiving, via one or more input devices in communication with the electronic device, one or more inputs defining a sequence of movement of the viewpoint in the virtual three-dimensional environment; and after receiving the one or more inputs, capturing the video content, including updating the viewpoint in the three-dimensional environment in accordance with the one or more inputs and updating the video in accordance with the viewpoint. Additionally or alternatively, in some examples, the method further includes displaying, using the display, a plurality of control elements associated with the viewpoint in the virtual three-dimensional environment; and receiving, via one or more input devices in communication with the electronic device, one or more inputs directed to the plurality of control elements, wherein the movement of the viewpoint in the three-dimensional environment in the video content is based on the one or more inputs directed to the plurality of control elements. Additionally or alternatively, in some examples, the movement of the viewpoint in the virtual three-dimensional environment in the video content is based on movement of a physical camera that captured real video footage. Additionally or alternatively, in some examples, the method further includes presenting, using the display, a second video content that concurrently includes a portion of the video content of the virtual three-dimensional environment and a portion of the real video footage. Additionally or alternatively, in some examples, the method further includes playing the video content; and while playing the video content, displaying movement of the representation of the viewpoint in the virtual three-dimensional environment in the three-dimensional model synchronized with playback of the video content.

Some examples of the disclosure are directed to a non-transitory computer readable storage medium storing instructions that, when executed by an electronic device including memory and one or more processors coupled to the memory causes the electronic device to perform a method comprising: concurrently displaying, using a display in communication with the electronic device: a three-dimensional model of a virtual three-dimensional environment including a representation of a viewpoint in the virtual three-dimensional environment; and content including an image of the virtual three-dimensional environment from the viewpoint, wherein in accordance with a determination that the viewpoint in the virtual three-dimensional environment is a first viewpoint, the image is a first image from the first viewpoint; and in accordance with a determination that the viewpoint in the virtual three-dimensional environment is a second viewpoint different from the first viewpoint, the image is a second image from the second viewpoint. Additionally or alternatively, in some examples, the method further includes in accordance with a determination that the image is displayed as a two-dimensional image, displaying, using the display, a selectable option that, when selected, causes the electronic device to display the image as a three-dimensional image; and in accordance with a determination that the image is displayed as a three-dimensional image, displaying, using the display, a selectable option that, when selected, causes the electronic device to display the image as the two-dimensional image. Additionally or alternatively, in some examples, the content includes video content that includes movement of the viewpoint in the virtual three-dimensional environment. Additionally or alternatively, in some examples, the method further includes capturing the video content, including: while displaying the video content receiving, via one or more input devices in communication with the electronic device, one or more inputs updating the viewpoint in the three-dimensional environment; and in response to receiving the one or more inputs, updating the viewpoint in the three-dimensional environment in accordance with the one or more inputs and updating the video in accordance with the viewpoint. Additionally or alternatively, in some examples, the method further includes prior to capturing the video content, receiving, via one or more input devices in communication with the electronic device, one or more inputs defining a sequence of movement of the viewpoint in the virtual three-dimensional environment; and after receiving the one or more inputs, capturing the video content, including updating the viewpoint in the three-dimensional environment in accordance with the one or more inputs and updating the video in accordance with the viewpoint. Additionally or alternatively, in some examples, the method further includes displaying, using the display, a plurality of control elements associated with the viewpoint in the virtual three-dimensional environment; and receiving, via one or more input devices in communication with the electronic device, one or more inputs directed to the plurality of control elements, wherein the movement of the viewpoint in the three-dimensional environment in the video content is based on the one or more inputs directed to the plurality of control elements. Additionally or alternatively, in some examples, the movement of the viewpoint in the virtual three-dimensional environment in the video content is based on movement of a physical camera that captured real video footage. Additionally or alternatively, in some examples, the method further includes presenting, using the display, a second video content that concurrently includes a portion of the video content of the virtual three-dimensional environment and a portion of the real video footage. Additionally or alternatively, in some examples, the method further includes playing the video content; and while playing the video content, displaying movement of the representation of the viewpoint in the virtual three-dimensional environment in the three-dimensional model synchronized with playback of the video content.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with a display:
concurrently displaying, using the display:
a three-dimensional model of a virtual three-dimensional environment including a representation of a viewpoint in the virtual three-dimensional environment; and
content including an image of the virtual three-dimensional environment from the viewpoint, wherein
in accordance with a determination that the viewpoint in the virtual three-dimensional environment is a first viewpoint, the image is a first image from the first viewpoint; and
in accordance with a determination that the viewpoint in the virtual three-dimensional environment is a second viewpoint different from the first viewpoint, the image is a second image from the second viewpoint.

2. The method of claim 1, further comprising:
in accordance with a determination that the image is displayed as a two-dimensional image, displaying, using the display, a selectable option that, when selected, causes the electronic device to display the image as a three-dimensional image; and
in accordance with a determination that the image is displayed as a three-dimensional image, displaying, using the display, a selectable option that, when selected, causes the electronic device to display the image as the two-dimensional image.

3. The method of claim 1, wherein the content includes video content that includes movement of the viewpoint in the virtual three-dimensional environment.

4. The method of claim 3, further comprising:
capturing the video content, including:
while displaying the video content:
receiving, via one or more input devices in communication with the electronic device, one or more inputs updating the viewpoint in the three-dimensional environment; and
in response to receiving the one or more inputs, updating the viewpoint in the three-dimensional environment in accordance with the one or more inputs and updating the video in accordance with the viewpoint.

5. The method of claim 3, further comprising:
prior to capturing the video content, receiving, via one or more input devices in communication with the electronic device, one or more inputs defining a sequence of movement of the viewpoint in the virtual three-dimensional environment; and
after receiving the one or more inputs, capturing the video content, including updating the viewpoint in the three-dimensional environment in accordance with the one or more inputs and updating the video in accordance with the viewpoint.

6. The method of claim 3, further comprising:
displaying, using the display, a plurality of control elements associated with the viewpoint in the virtual three-dimensional environment; and
receiving, via one or more input devices in communication with the electronic device, one or more inputs directed to the plurality of control elements, wherein the movement of the viewpoint in the three-dimensional environment in the video content is based on the one or more inputs directed to the plurality of control elements.

7. The method of claim 3, wherein the movement of the viewpoint in the virtual three-dimensional environment in the video content is based on movement of a physical camera that captured real video footage.

8. The method of claim 7, further comprising:
presenting, using the display, a second video content that concurrently includes a portion of the video content of the virtual three-dimensional environment and a portion of the real video footage.

9. An electronic device comprising:
memory; and
one or more processors coupled to the memory and configured to perform a method comprising:
concurrently displaying, using a display in communication with the electronic device:
a three-dimensional model of a virtual three-dimensional environment including a representation of a viewpoint in the virtual three-dimensional environment; and
content including an image of the virtual three-dimensional environment from the viewpoint, wherein
in accordance with a determination that the viewpoint in the virtual three-dimensional environment is a first viewpoint, the image is a first image from the first viewpoint; and
in accordance with a determination that the viewpoint in the virtual three-dimensional environment is a second viewpoint different from the first viewpoint, the image is a second image from the second viewpoint.

10. The electronic device of claim 9, wherein the method further comprises:
in accordance with a determination that the image is displayed as a two-dimensional image, displaying, using the display, a selectable option that, when selected, causes the electronic device to display the image as a three-dimensional image; and
in accordance with a determination that the image is displayed as a three-dimensional image, displaying, using the display, a selectable option that, when selected, causes the electronic device to display the image as the two-dimensional image.

11. The electronic device of claim 9, wherein the content includes video content that includes movement of the viewpoint in the virtual three-dimensional environment.

12. The electronic device of claim 11, wherein the method further comprises:
capturing the video content, including:
while displaying the video content:
receiving, via one or more input devices in communication with the electronic device, one or more inputs updating the viewpoint in the three-dimensional environment; and
in response to receiving the one or more inputs, updating the viewpoint in the three-dimensional environment in accordance with the one or more inputs and updating the video in accordance with the viewpoint.

13. The electronic device of claim 11, wherein the method further comprises:
prior to capturing the video content, receiving, via one or more input devices in communication with the electronic device, one or more inputs defining a sequence of movement of the viewpoint in the virtual three-dimensional environment; and
after receiving the one or more inputs, capturing the video content, including updating the viewpoint in the three-dimensional environment in accordance with the one or more inputs and updating the video in accordance with the viewpoint.

14. The electronic device of claim 11, wherein the method further comprises:
displaying, using the display, a plurality of control elements associated with the viewpoint in the virtual three-dimensional environment; and
receiving, via one or more input devices in communication with the electronic device, one or more inputs directed to the plurality of control elements, wherein the movement of the viewpoint in the three-dimensional environment in the video content is based on the one or more inputs directed to the plurality of control elements.

15. The electronic device of claim 11, wherein the movement of the viewpoint in the virtual three-dimensional environment in the video content is based on movement of a physical camera that captured real video footage.

16. The electronic device of claim 15, wherein the method further comprises:
presenting, using the display, a second video content that concurrently includes a portion of the video content of the virtual three-dimensional environment and a portion of the real video footage.

17. A non-transitory computer readable storage medium storing instructions that, when executed by an electronic device including memory and one or more processors coupled to the memory causes the electronic device to perform a method comprising:
concurrently displaying, using a display in communication with the electronic device:
a three-dimensional model of a virtual three-dimensional environment including a representation of a viewpoint in the virtual three-dimensional environment; and
content including an image of the virtual three-dimensional environment from the viewpoint, wherein
in accordance with a determination that the viewpoint in the virtual three-dimensional environment is a first viewpoint, the image is a first image from the first viewpoint; and
in accordance with a determination that the viewpoint in the virtual three-dimensional environment is a second viewpoint different from the first viewpoint, the image is a second image from the second viewpoint.

18. The electronic device of claim 17, wherein the method further comprises:
in accordance with a determination that the image is displayed as a two-dimensional image, displaying, using the display, a selectable option that, when selected, causes the electronic device to display the image as a three-dimensional image; and
in accordance with a determination that the image is displayed as a three-dimensional image, displaying, using the display, a selectable option that, when selected, causes the electronic device to display the image as the two-dimensional image.

19. The electronic device of claim 17, wherein the content includes video content that includes movement of the viewpoint in the virtual three-dimensional environment.

20. The electronic device of claim 19, wherein the method further comprises:
capturing the video content, including:
while displaying the video content:
receiving, via one or more input devices in communication with the electronic device, one or more inputs updating the viewpoint in the three-dimensional environment; and
in response to receiving the one or more inputs, updating the viewpoint in the three-dimensional environment in accordance with the one or more inputs and updating the video in accordance with the viewpoint.

21. The electronic device of claim 19, wherein the method further comprises:
prior to capturing the video content, receiving, via one or more input devices in communication with the electronic device, one or more inputs defining a sequence of movement of the viewpoint in the virtual three-dimensional environment; and
after receiving the one or more inputs, capturing the video content, including updating the viewpoint in the three-dimensional environment in accordance with the one or more inputs and updating the video in accordance with the viewpoint.

22. The electronic device of claim 19, wherein the method further comprises:
displaying, using the display, a plurality of control elements associated with the viewpoint in the virtual three-dimensional environment; and
receiving, via one or more input devices in communication with the electronic device, one or more inputs directed to the plurality of control elements, wherein the movement of the viewpoint in the three-dimensional environment in the video content is based on the one or more inputs directed to the plurality of control elements.

23. The electronic device of claim 19, wherein the movement of the viewpoint in the virtual three-dimensional environment in the video content is based on movement of a physical camera that captured real video footage.

24. The electronic device of claim 23, wherein the method further comprises:
presenting, using the display, a second video content that concurrently includes a portion of the video content of the virtual three-dimensional environment and a portion of the real video footage.
